(19) United States
(12) Patent Application Publication
(10) Pub. No.: US 2010/0118722 A1
(43) Pub. Date: May 13, 2010

(54) System And Method For Providing Data Streaming And Timing Information With Missing Package Recovery

(75) Inventors: Pullan Lu, Irvine, CA (US); Yeejang James Lin, San Jose, CA (US)

Correspondence Address: Wang Law Firm, Inc., 4989 Peachtree Parkway,, Suite 200, Norcross, GA, 30092, US

(73) Assignee: CHALET TECHNOLOGY, Taipei (TW)

(21) Appl. No.: 12/610,716

(22) Filed: Nov. 2, 2009

Related U.S. Application Data
(60) Provisional application No. 61/113,726, filed on Nov. 12, 2008.

(51) Int. Cl. H04L 12/26; H04J 3/24; G06F 17/30

(52) U.S. Cl. 370/252; 370/474; 707/769; 707/E17.014

(57) ABSTRACT

The present invention provides a monitoring device and method for supplying timing information for a data stream assembled from data packets and also for assembling a replacement data packet when a data packet is missing. The data packets received from a data network and the start time and the end time of each data packet are recorded. After assembling a data stream from the data packets, the start time of the data stream is the first start time of the first data packet and the end time of the data stream is the last end time of the last data packet. When a data packet is missing, a replacement data packet is assembled with a predefined value and the timing information is copied from the timing information from the data packet that follows the missing data packet.

### RELATED APPLICATION

This application claims benefits of the U.S. Provisional Application for A Method To Provide TCP/UDP Streaming And Timing Information, U.S. Provisional Pat. App. No. 61/113,726, filed on Nov. 12, 2008, the specification of which is included in its entirety by this reference.

### BACKGROUND OF THE INVENTION

1. Field of the Invention

The present invention generally relates to real time event monitoring, and more specifically, relates to a system and method that handle data packets in a data network.

2. Description of the Related Art

During monitoring of a network, it is often necessary to monitor or copy data packets that traffic through the network. The information is transmitted as data packets according to different data transmission protocols and one of most common protocols is Transmission Control Protocol. The information is broken into data packets and then transmitted over a data network. The data packets are assembled at their destination.

During the transmission, the data packets may arrive out of order or be lost. The TCP detects these problems and can request retransmission of lost packets and rearrange out-of-order packets. However, when a monitoring system loses data when copying data packets, the monitoring system cannot request retransmission of data packets and good portion of data may not be properly analyzed by the monitoring system. Another shortcoming about the TCP is that there is no timing information in the reassembled data and thus the monitoring system cannot measure or detect the performance of the system that is being monitored.

Therefore, there is a need for a system and method that provides timing information to a reassembled data stream and also handles missing data packets and it is to this system the present invention is primarily directed.

### SUMMARY OF THE INVENTION

In one embodiment, the present invention provides a method for adding timing information to a data stream assembled from data received from a data network. The method comprises receiving data from a monitoring port, recording a start time and an end time of the received data, storing the received data in the storage unit, storing an offset address pointing to the received data, and storing the start time and the end time adjacent to the offset address.

In another embodiment, there is also provided a method for assembling information for missing data packets. The method comprises receiving a plurality of data packets from a network, each data packet having a start time and an end time, detecting a missing data packet, creating a replacement data packet with a predefined value as a content, and assigning a start time of a data packet following the missing data packet as both the start time and the end time of the replacement data packet.

In another embodiment, there is also provided a monitoring device for adding timing information to a data stream assembled from data packets received from a network. The monitoring device comprises at least one monitoring port for receiving data packets from the network, a controller for recording a start time and an end time for each data packet, assembling data packets into a data stream, and deriving a timing information for the data stream, and a storage unit for storing the data stream at a location pointed by a pointer, wherein the controller stores the timing information adjacent to an offset address for the data stream.

The present system and methods are therefore advantageous as they enable timing information of data to be manipulated by a monitoring system. Other advantages and features of the present invention will become apparent after review of the hereinafter set forth Brief Description of the Drawings, Detailed Description of the Invention, and the Claims.

### BRIEF DESCRIPTION OF THE DRAWINGS

Features and advantages of embodiments of the invention will become apparent as the following detailed description proceeds, and upon reference to the drawings, where like numerals depict like elements, and in which:

FIG. 1 depicts a network architecture according to the present invention;

FIG. 2 illustrates a data request transaction on a network;

FIG. 3 illustrates an architecture for placing a stream timing channel;

FIG. 4 illustrates implementation of a stream timing channel;

FIG. 5 is an illustration of timing information for a transaction;

FIG. 6 illustrates a process for assembling data stream for the query;

FIG. 7 illustrates a process for assembling data stream for the response;

FIG. 8 illustrates the transaction with missing data packets;

FIG. 9 illustrates assembly of data stream with missing data packets;

FIG. 10 illustrates a process for handling missing data packets; and

FIG. 11 is architecture for a monitoring device.

### DETAIL DESCRIPTION OF THE INVENTION

In this description, the term “application” as used herein is intended to encompass executable and non-executable software files, raw data, aggregated data, patches, and other code segments. The term “exemplary” is meant only as an example, and does not indicate any preference for the embodiment or elements described. Further, like numerals refer to like elements throughout the several views, and the articles “a” and “the” includes plural references, unless otherwise specified in the description.

In an overview, the present invention provides a system and method for adding timing information to a data stream reassembled from data packets and also for handling missing data packets.

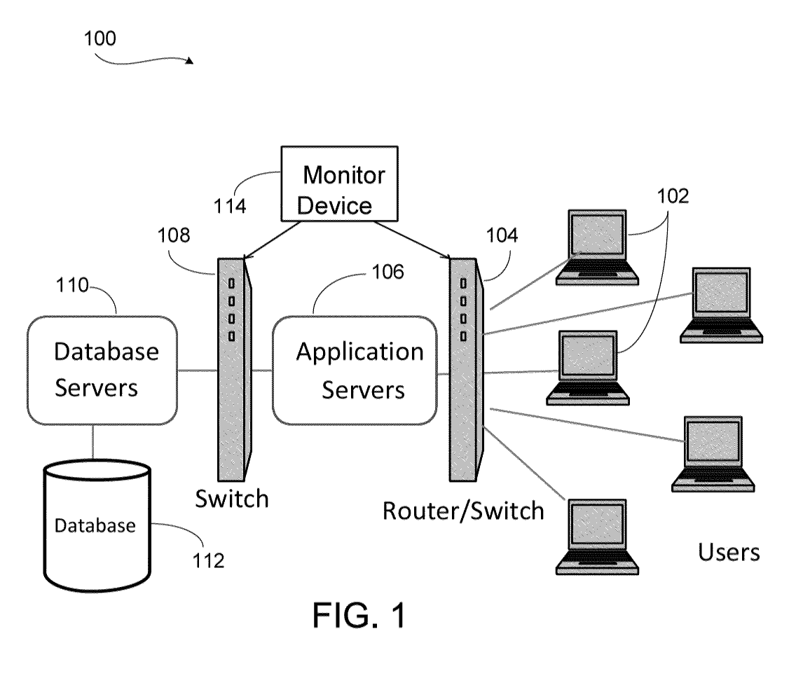

FIG. 1 illustrates a network architecture 100 according to the present invention. The remote users may use any of computers, workstations, or terminals 102 connected to a data network or a switch/router 104. The users may be workers in a company located in one single location or located in different geographical areas. A user may run an application located on an application server 106 and during execution of the application, requests for certain information located in a database 112 may be requested by the user. The request initiated from a terminal 102 is sent through the router 104 to the application server 106. The application server 106 sends the request to a database server 110. The database server 110 may be connected directly to the application server 106 or may be located remotely from the application server 106 and connected to the application server 106 through a switch 108. After receiving the request, the database server 110 can then retrieve the requested data from a database 112. The requested data then travels back to the terminal 102 from which the request was initiated.

The requests that travel from the terminals 102 are generally transferred as data packets on the network and the common protocol for the data transfer is TCP or UDP. The requests are parsed and transmitted by one or more data packets. These data packets are received and reassembled by the database server 110. The assembly of received data packets to restore the original data is known as streaming. The reassembly of the data is according to the order of the data packets. During transmission, data packets may be lost and when this happens, the database server 110 will request the retransmission of the lost data.

To monitor the access to the database server 110 a monitoring device 114 is introduced. The monitoring device 114 monitors data traffic passing through the router 104 and switch 108. Each request from a remote terminal 102 is recorded as an instance and its content analyzed. Each response from the database server 110 is also recorded as an instance and analyzed. The monitoring device 114 monitors these requests and responses by making copies of every data packets that travel through the monitoring point. The monitoring device 114 reassembles these data packets as the database server 110 would.

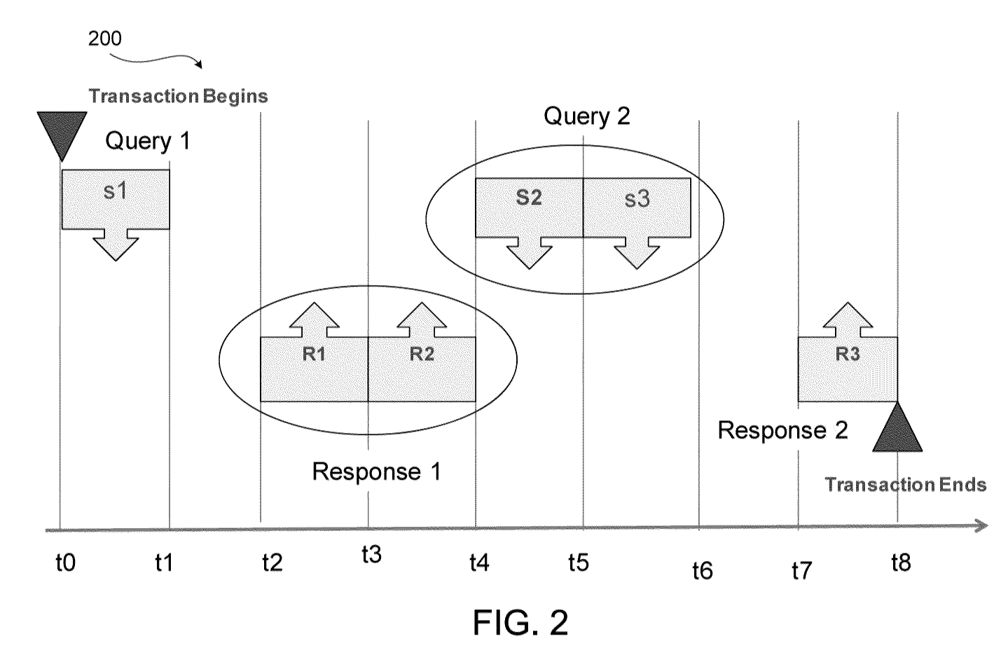

FIG. 2 illustrates a transaction 200 on a network. A transaction 200 may involve one or multiple queries and responses. The transaction 200 begins at time t0 when a query 1 (S1) is sent from a remote terminal 102. (S1), (S2, S3), (R1, R2), and (R3) represent data packets traveling on the network. (S2, S3) may travel separately and (R1,R2) may also travel separately. The time is referenced at the monitoring point, where the observation is made. The query 1 causes a response (R1, R2) from the database server 110 that starts from t2 and ends on t4. The transaction 200 may involve another query 2 (S2, S3), which will causes another response 2 (R3) from the database server 110. The transaction 200 ends at time t8 when response 2 (R3) passes through the monitoring point. Normally, the steaming allows the original data be reassembled through the data packets. For example, response 1 is assembled from (R1, R2), and no timing information is captured from the reassembly of the data packets.

The present invention provides a novel way to add timing information to the captured data packets and this timing information is useful in determining performance of each transaction. One way to add the timing information is to record a timestamp for each query and response and the other timing information can then be easily derived. The timestamp consists of the start time and end time of each query and response. For example, for query 1 S1, the start time is t0 and the end time is t1, and it is denoted as S1 (t0, t1). For response 1 R1 and R2, the timestamp would be R1/R2 (t2, t4). The response time is the time between a request is transmitted and a response is detected. The response time for query 1 is (S1, R1, R2)=t2−t1; the response time for query 2 is (S2, S3, R3)=t7−t6. The transmission time is the actual time that data packets are in transit. The transmission time for query 1 and response 1 is (S1, R1, R2)=(t1−t0)+(t4−t2), and the transmission time for query 2 and response 2 is (S2, S3, R3)=(t6−t4)+(t8−t7). The transaction time is the time for a transaction to be completed. One transaction may take multiple queries and responses. The transaction time for transaction 200 is (t8−t0).

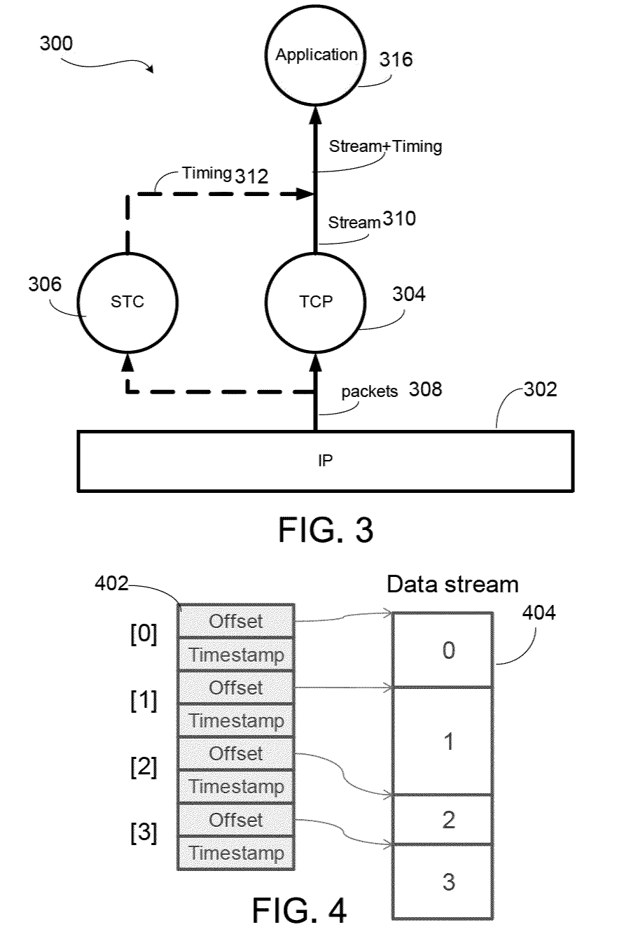

The advantages of collecting and measuring time information are many. The performance of the system can be measured and system anomalies may also be detected. FIG. 3 illustrates an architecture 300 for placing a stream timing channel (STC) 306. The TCP controller 304 receives data packets 308 from the Internet (IP) 302 and assembles them into stream 310. The STC monitors the flow of data packets 308 and creates timing information 312 and makes this timing information 312 available along with the steam 310 to an application 316. The STC is a mechanism that manages timing information of received data segments. The timing information allows the application to readily tell the arrival time of an interested data segment.

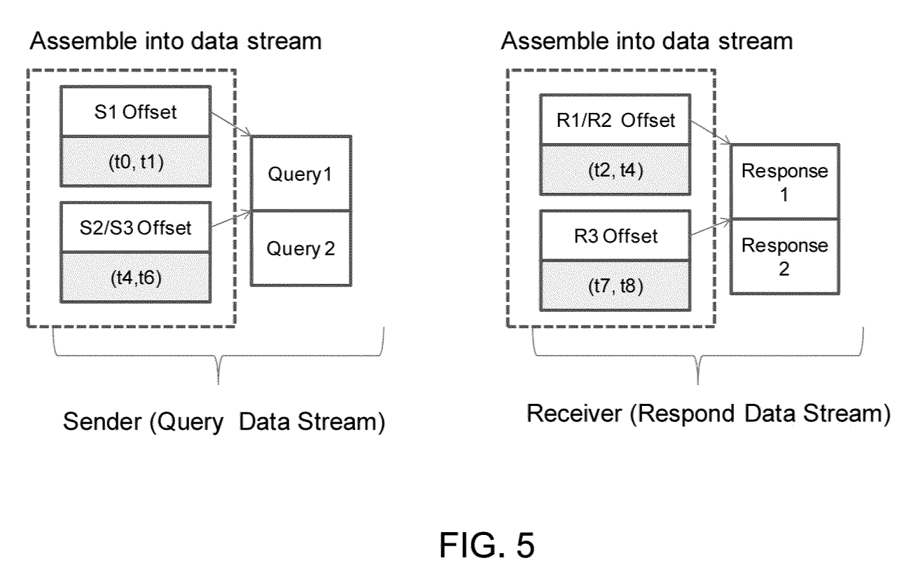

FIG. 4 illustrates implementation of a STC 306. Normally, a data stream 404, after being assembled, is identified by a pointer that includes a table 402 with offset addresses; each offset address identifies the beginning address of a data segment. The table 402 may be part of a pointer pointing to the physical location of the data stream 404. Each segment, 0, 1, 2, and 3, of the data stream 404 is associated with an offset address. The timing information captured by the STC 306 is inserted into the table 402. FIG. 5 is an illustration of timing information for the transaction 200 of FIG. 2. Each query, query 1 and query 2, is associated with an offset address and a timing information is placed adjacent to each offset address information. Similar timing information is assembled for the responses. The adjacency between the timing information and the offset address information may be physical or logical. As it can be seen from FIG. 5, when a data stream is assembled from multiple data packets, such as query 2 is assembled from S2 and S3, the start time of the data stream is the start time of the first data packet (S2) and the end time of the data stream is the end time of the last data packet (S3).

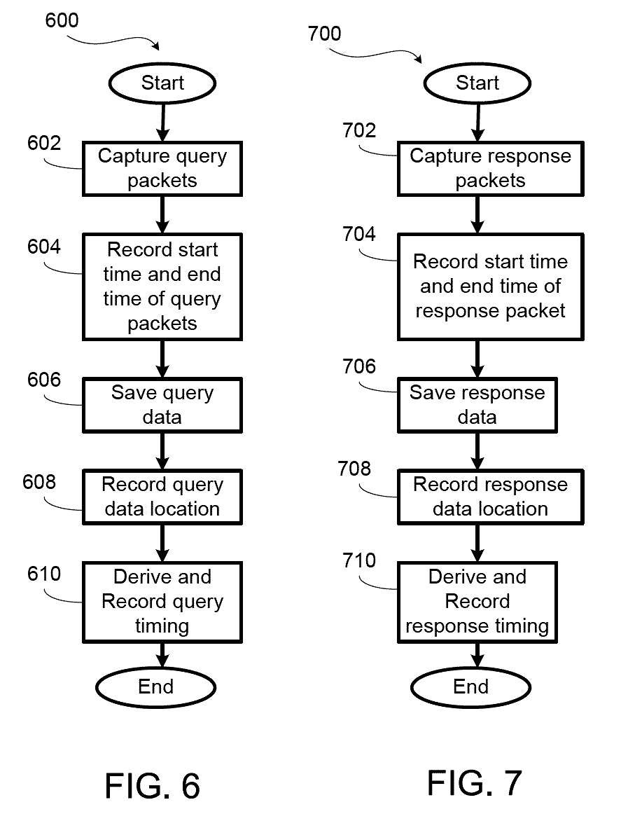

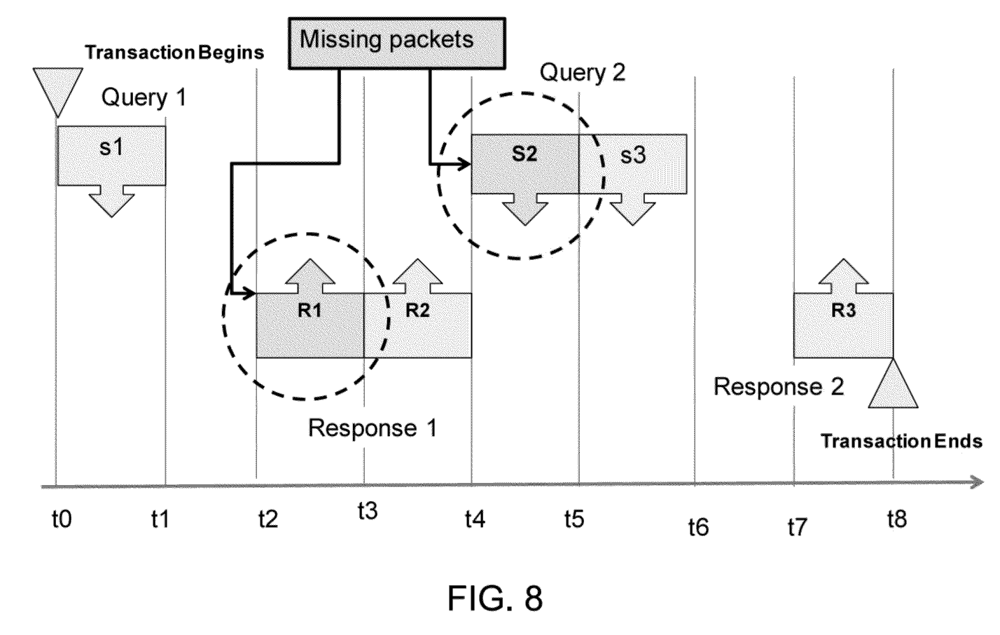

FIG. 6 illustrates a process 600 for assembling data stream for the query. The data packets related to the query is captured or copied, step 602. The start time and end time for each packet is recorded, step 604. For example of query 1 shown in FIG. 2, the start time is t0 and the end time is t1. The query data is saved, step 606, and offset of each data location is recorded, step 608. The timing information about the query data is also derived and recorded, step 610. The timing information is derived as described in FIG. 5. FIG. 7 illustrates a process 700 for assembling data stream for the response. The data packets related to the response is captured or copied, step 702. The start time and end time for each packet is recorded, step 704. For example of response 1 shown in FIG. 2 involves two data packets, R1 and R2, the start time is t2 and the end time is t4. The response data is saved, step 706, and offset of each data location is recorded, step 708. The timing information about the response data is also derived and recorded, step 710.

The timing information for each query and response is useful in determining the system performance and also to detect any anomalies. If any transaction, i.e., query and response, takes more time than usually, this may be an indication about some anomaly in the system.

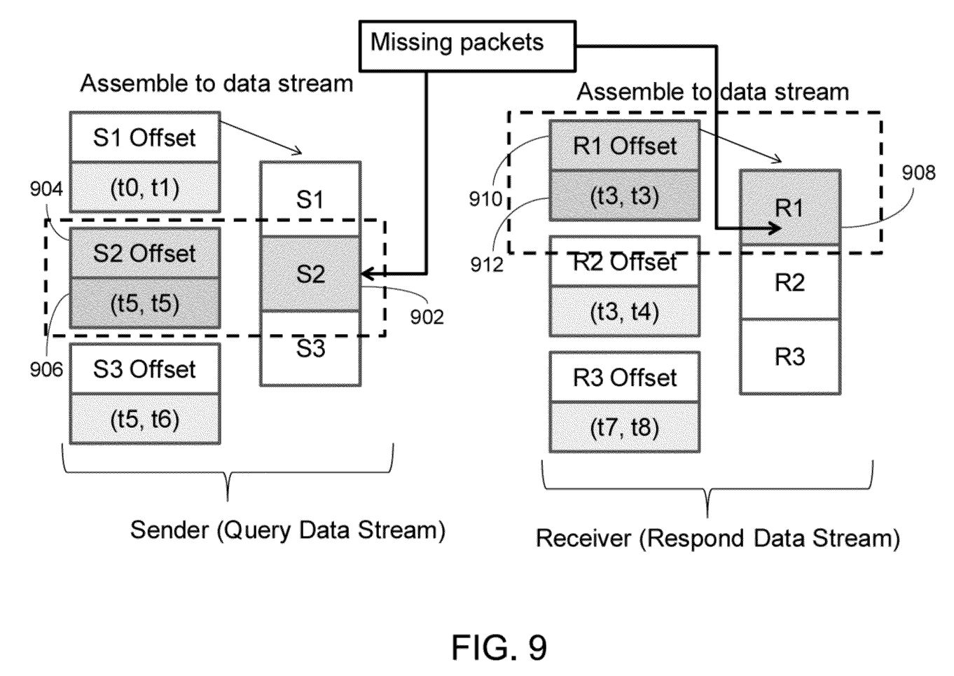

When monitoring a system, because of amount of data monitored and limitation of resources (memory and CPU power), it is possible that few data packets may be missed. In a data transfer, when a data packet is lost, the TCP protocol simply dictates that the missing data to be resent. Retransmission is a logical approach to receive the missing data, however, it is not an available solution when the monitoring system fails to record a data. The monitoring system cannot request retransmission of missing data and the monitoring must continue despite of missing a data. However, missing data makes processing impossible. FIG. 8 illustrates the transaction 200 with missing data packets. To fix this missing data packet, replacement data packets are created. The replacement data packet is placed at the offset of missing data packet and with the same length. The content of the replacement data packet is replaced with a known marker or a predefined value. This well known marker enables the missing content to be ignored. The missing timing information associated with the missing data packets are set equal to the timestamp of next available data packet or the beginning time of next available packet. For the example shown in FIG. 2, the time for the missing pack R1 would be (t3, t3) and the time for missing S2 would be (t5, t5) as illustrated by FIG. 9.

As it can be seen in FIG. 9, the missing data packet S2 is replaced by a replacement data 902 packet in the data stream. The offset address for the missing packet and length of missing packets are calculated from sequence numbers of previous and next packets. The content of the replacement packet is filled with a predefined marker and the timing information is replaced by the timestamp of next available data packet. The start time of the next data packet is assigned as the start time and the end time of the replacement packet, which is t5. Similarly, the missing packet for R1 is replaced by the replacement packet 908 and the offset address for replacement packet is set to a predefined address 910. The timing information 912 is again replaced by the timing information of R2. By replacing the missing data packets with replacement packets, the monitoring system can continue to monitor the data requests and their corresponding responses.

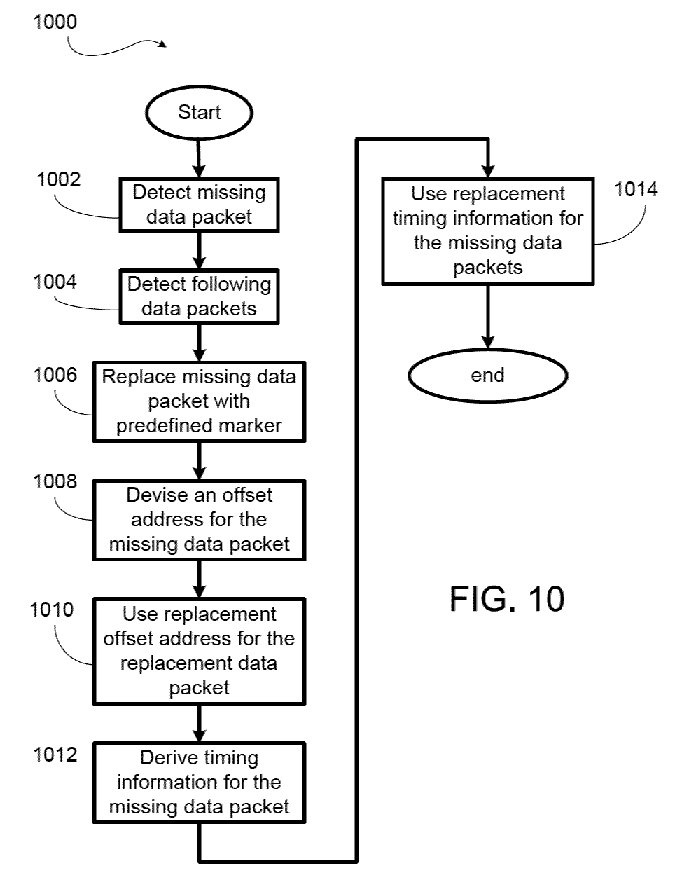

FIG. 10 illustrates a process 1000 for assembling information for missing data packets. When a data packet is missing, step 1002, the monitoring system will detect this fact when other following data packets are received, step 1004. The monitoring system will create a replacement data packet to replace the missing data packet and fill this replacement data packet with a predefined marker, step 1006. A replacement offset address is created for the replacement data packet, step 1008, and the replacement offset address is used for the replacement data packet, step 1010. The monitoring system will use the timing information from the next data packet that follows the missing data packet as the timing information for the replacement data packet, step 1012, and this replacement timing information is inserted in the table of pointers for the data stream and used as the timing information for the replacement data packet, step 1014.

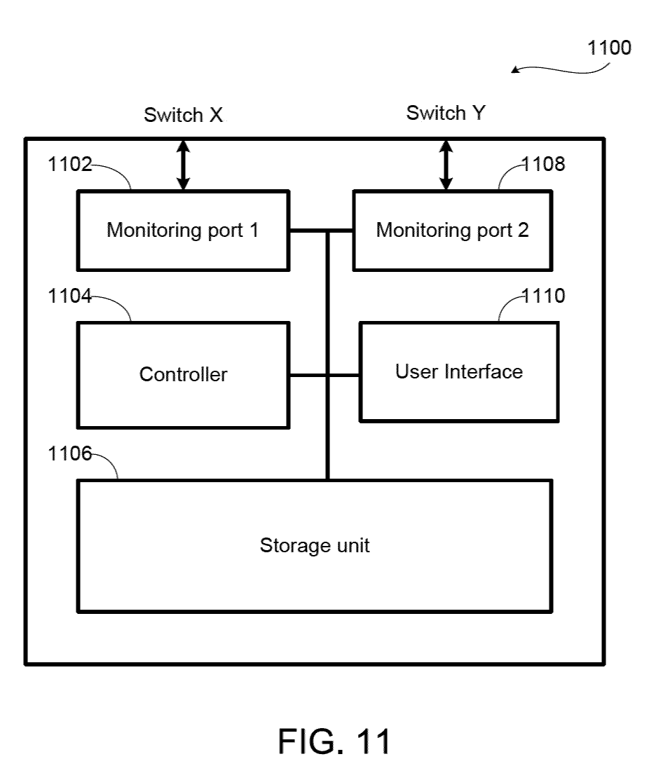

The method of the present invention can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a networking computer platform, such as a magnetic disk or tape, optical disk, hard disk, flash memory, or other storage media as is known in the art. A system supporting such method is shown in FIG. 11.

FIG. 11 is architecture 1100 for a monitoring device 114. The monitoring device 114 may have one or more monitoring port, 1102, 1108, for connecting to two or more monitoring points. The monitoring device 114 includes a controller 1104, a user interface unit 1110, and a storage unit 1106. The controller 1104 checks the collected data captured by the monitoring ports 1102 and 1108, assembles a data stream from the capture data, and stores it in the storage unit 1106. The timing information for the data stream is derived from the start time of the first data packet and an end time of the last data packet in the data stream. The user interface unit 1110 displays the data stream to the system administrator and receives commands from the system administrator. The controller 1104 will detect a data packet is missing when reassembling the captured data. When the controller 1104 detects a missing data packet, the controller 1104 will assemble a replacement data and use timing information from the following data packet for the replacement data. Though separate units are shown, they can easily be replaced by one or multiple hardware units capable of performing similar functions.

In the context of FIG. 10, the steps illustrated do not require or imply any particular order of actions. The actions may be executed in sequence or in parallel. The method may be implemented, for example, by operating portion(s) of a network device, such as a network router or network server, to execute a sequence of machine-readable instructions. The instructions can reside in various types of signal-bearing or data storage primary, secondary, or tertiary media. The media may comprise, for example, RAM (not shown) accessible by, or residing within, the components of the network device. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch” cards, or other suitable data storage media including digital and analog transmission media. The instructions when executed by a computer will enable the computer to perform the steps illustrated in FIG. 10.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated. The combinations of different features described separately in this specification are foreseeable and within the scope of the invention.

What is claimed is:

1. A method for adding timing information to a data stream assembled from data received from a data network, comprising the steps of:
receiving data from a monitoring port;
recording a start time and an end time of the received data;
storing the received data in the storage unit;
storing an offset address pointing to the received data; and
storing the start time and the end time adjacent to the offset address.

2. The method of claim 1, wherein the data being a query to a database.

3. The method of claim 1, wherein the data being a response to a query to a database.

4. The method of claim 1, wherein the data further comprising a plurality of data packets and the step of recording the start time and the end time of the received data further comprising the step of recording a start time and an end time of each data packet.

5. A method for assembling information for missing data packets, comprising the steps of:
receiving a plurality of data packets from a network, each data packet having a start time and an end time;
detecting a missing data packet;
creating a replacement data packet with a predefined value as a content; and
assigning a start time of a data packet following the missing data packet as the start time and the end time of the replacement data packet

6. The method of claim 5, wherein the plurality of data packets being a query to a database.

7. The method of claim 5, wherein the plurality of data packets being a response to a query to a database.

8. The method of claim 5, further comprising the step of assigning an offset address of the data packet following the missing data packet as the offset address of the replacement data packet.

9. The method of claim 5, further comprising the step of storing the start time and the end time of the replacement data packet adjacent to an offset address pointing to the replacement data packet.

10. A monitoring device for adding timing information to a data stream assembled from data packets received from a network, comprising:
at least one monitoring port for receiving data packets from the network;
a controller for recording a start time and an end time for each data packet, assembling data packets into a data stream, and deriving a timing information for the data stream; and
a storage unit for storing the data stream at a location pointed by a pointer,
wherein the controller stores the timing information adjacent to an offset address for the data stream.

11. The monitoring device of claim 10, further comprising a user interface unit for displaying the data stream to a user.

12. The monitoring device of claim 10, wherein the controller further derives the timing information for the data stream by using a start time of a first data packet in the data stream and an end time of a last packet in the data stream.

13. The monitoring device of claim 10, wherein the controller further detects a missing data packet.

14. The monitoring device of claim 13, wherein the controller assembles a replacement data packet by filling the replacement data packet with a predefined value.

15. The monitoring device of claim 13, wherein the controller assembles a timing information for the replacement data packet by using the timing information from a data packet that follows the missing data packet.
